(19) United States
(12) Patent Application Publication
(10) Pub. No.: US 2014/0161288 A1
(43) Pub. Date: Jun. 12, 2014

(54) ELECTROACOUSTICAL TRANSDUCING

(71) Applicants: Eric J. Freeman, Sutton, MA (US); Michael W. Stark, Acton, MA (US); William Berardi, Grafton, MA (US); Klaus Hartung, Hopkinton, MA (US)

(72) Inventors: Eric J. Freeman, Sutton, MA (US); Michael W. Stark, Acton, MA (US); William Berardi, Grafton, MA (US); Klaus Hartung, Hopkinton, MA (US)

(21) Appl. No.: 13/970,361

(22) Filed: Aug. 19, 2013

Related U.S. Application Data
(63) Continuation of application No. 11/499,014, filed on Aug. 4, 2006, now abandoned.

(51) Int. Cl. H04R 1/02

(52) U.S. Cl. CPC H04R 1/02
USPC 381/152

(57) ABSTRACT

Electroacoustical apparatus includes at least first and second acoustically coupled electroacoustical drivers. An electrical network couples their inputs so that an electrical drive signal applied to one reduces the effect of acoustic coupling from that one to the other.

### CROSS REFERENCE TO RELATED APPLICATIONS

This application claims priority to U.S. application Ser. No. 11/499,014, filed on Aug. 4, 2006, the entire content of which is incorporated by reference.

### FIELD OF THE INVENTION

This description relates in general to electroacoustical transducing, and more particularly concerns novel apparatus and techniques for electroacoustical transducing with a plurality of acoustically coupled electroacoustical transducers.

### BACKGROUND OF THE INVENTION

For background, reference is made to U.S. Pat. Nos. 4,146,745 and 4,146,744.

### SUMMARY OF THE INVENTION

According to the invention, there are at least first and second acoustically coupled electroacoustical drivers having first and second inputs respectively for receiving first and second electrical drive signals respectively. An electrical network intercouples the first and second inputs and is constructed and arranged to provide a first opposition signal on said second input in phase opposition to a first electrical drive signal on said first input to reduce the effect of acoustic coupling from the first electroacoustical driver to the second electroacoustical driver when the first electrical drive signal is applied to the first input. There may be a common cabinet enclosure enclosing the first and second electroacoustical drivers. The first and second electroacoustical drivers may be of the same design or of differing designs. The electrical network may be constructed and arranged to provide a second opposition signal on the first input in phase opposition to a second electrical drive signal on the second input to reduce the effect of acoustic coupling from the second electroacoustical driver to the first electroacoustical driver when the second electrical driver signal is applied to the second input.

Other features, objects and advantages will become apparent from the following detailed description when read in connection with the accompanying drawing in which:

### BRIEF DESCRIPTION OF DRAWING

FIG. 1 is a combined pictorial-block diagram of an exemplary embodiment of the invention;

FIG. 2 is a combined pictorial-block diagram of a modification of the embodiment shown in FIG. 1;

FIG. 3 is a graphical representation of the excursion transfer function X_{—}21 with and without an H_{—}22 filter;

FIG. 4 is a graphical representation of net excursion attenuation;

FIG. 5 is a perspective view of the commercially available Bose Companion 5 satellite speakers; and

FIG. 6 is a block diagram of an embodiment with filters 16 and 16′ and summing circuits 17 and 17′.

### DETAILED DESCRIPTION

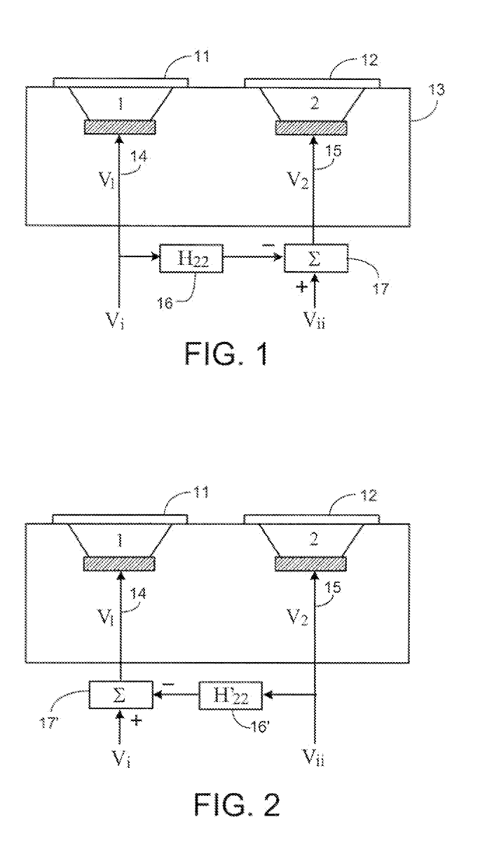

With reference now to the drawing and more particularly FIG. 1, there is shown a combined pictorial-block diagram of an embodiment of the invention. Electroacoustical transducer 1 11 and electroacoustical transducer 2 12 reside in enclosure 13 and have first and second inputs 14 and 15, respectively, for receiving first and second electrical drive signals V₁ and V₂, respectively. The first filter 16, having a transfer characteristic H₂₂, couples input 14 to the −input of summing circuit 17 whose +input receives a second input signal Vᵢᵢ and provides as an output the electrical drive signal V₂.

Having described the physical arrangement of the embodiment, the mode of operation will be described. It is convenient to describe the mechanical excursion of the cone of transducer 2 in response to the electrical drive signal V₁ caused by acoustic coupling from the movement of the cone of transducer 1 as X₂₁ per unit of V₁ and its mechanical excursion in response to the electrical drive signal V₂ as X₂₂ per unit of V₂. The resultant excursion X₂ of the cone of transducer 2 in response to the input signals Vᵢ , and Vᵢᵢ in the absence of circuits 16 and 17 is:

$$\begin{matrix}{X}_{2} = {V}_{1} * {X}_{21} + {V}_{2} * {X}_{22} & ( 1 ) \\ = {V}_{i} * {X}_{21} + {V}_{ii} * {X}_{22} & ( 1 a )\end{matrix}$$

It is convenient to define a filter based on the first two transfer functions as:

H₂₂=X₂₁/X₂₂ (2)

The output signal from filter 16 with transfer characteristic H₂₂ corresponds to the input signal V₁ multiplied by transfer characteristic H₂₂. Applying this output signal with phase reversed through summing circuit 17 creates a component of the electrical drive signal V₂ applied to transducer 2 that cancels the sympathetic vibration of transducer 2 caused by the acoustic coupling from transducer 1 in enclosure 13.

The modified excursion of transducer 2, X₂′, is expressed:

X₂′=X₂−Vᵢ*H₂₂*X₂₂ (3)

Substituting equations (1a) and (2) for terms X₂ and H₂₂ respectively gives:

X₂′=Vᵢ*X₂₁+Vᵢᵢ*X₂₂−Vᵢ*(X₂₁/X₂₂)*X₂₂ (4)

Note that the first and third terms of equation (4) cancel, leaving:

X₂′=Vᵢᵢ*X₂₂ (5)

So the mechanical response of the cone of transducer 2 to the input Vi is identically 0.

Referring to FIG. 2, there is shown another embodiment of the invention having a second filter 16′ having a transfer characteristic H′₂₂ providing an output delivered to the −input of summing circuit 17′ that receives the input signal Vᵢ on the +input to provide a signal V₁′ including a component that cancels the sympathetic vibration of transducer 1 in response to the signal V₂.

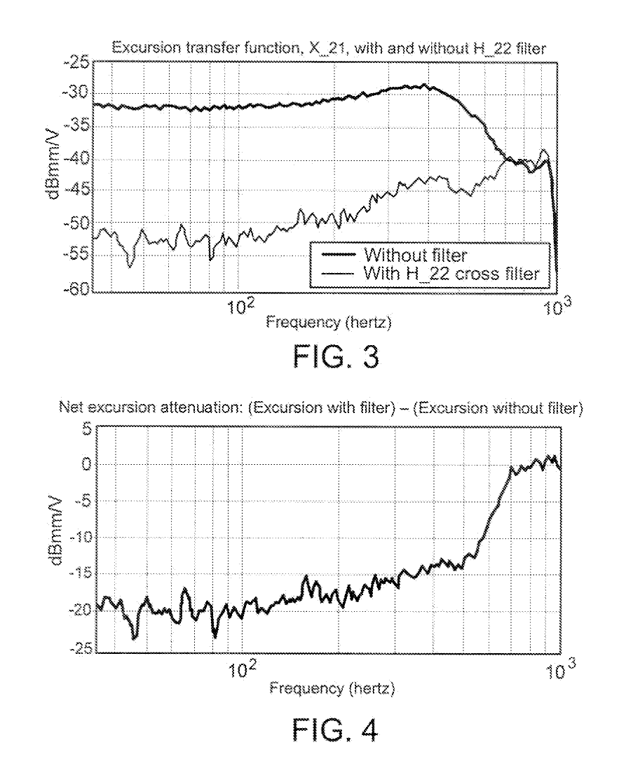

Referring to FIG. 3, there is shown a graphical representation of the excursion transfer function X₂₁ as a function of frequency with and without filter 16, respectively. Referring to FIG. 4, there is shown a graphical representation of the net excursion attenuation with filter minus excursion without filter.

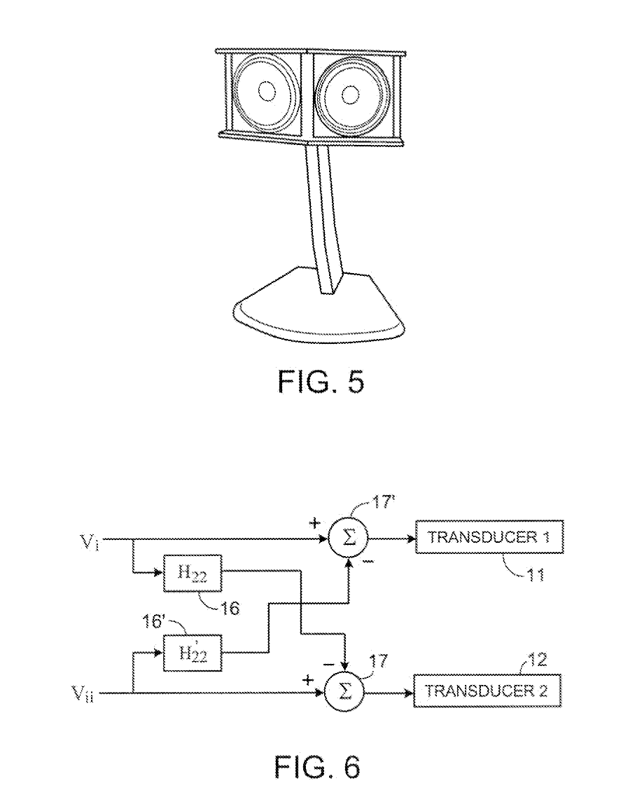

Referring to FIG. 5, there is shown a perspective view of a commercial embodiment of the invention in the Bose Companion 5 satellite cabinet enclosure showing transducers 1 and 2 in a sealed enclosure. In the specific embodiment of this invention, transducers 1 and 2 are 50 mm drivers in a sealed cabinet enclosure angled at 51 degrees with the enclosure volume 11.1 inch³.

Referring to FIG. 6, there is shown a block diagram of an embodiment showing filter 16 and 16′ and summing circuits 17 and 17′ combined. In a specific form of the invention a Texas Instruments DA708E001RFP250 DSP chip loaded with the ASCII representation of hex code in the appended text file implements the sympathetic vibration cancellation.

While the invention has been illustrated with two electroacoustical drivers, the principles of the invention may be extended to a larger plurality of drivers.

The invention has a number of advantages. In a system where a plurality of drivers in a common enclosure each receive different signals, the distortion in the acoustic output generated by any one of the drivers due to the acoustic coupling between it and the other drivers is significantly reduced. It helps maintain the excursion of the driver cones within the linear region of the transducers to facilitate reproducing sound at substantial levels without audible distortion. It is evident that those skilled in the art may now make numerous uses and modifications of and departures from the specific embodiments disclosed herein without departing from the inventive concepts. Consequently, the invention is to be construed as embracing each and every novel feature and novel combination of features present in or possessed by the apparatus and techniques herein disclosed and limited only by the spirit and scope of the appended claims.

What is claimed is:

1. An electroacoustical apparatus comprising:
a cabinet enclosure,
at least first and second electroacoustical drivers acoustically coupled in said cabinet enclosure each having an input for receiving respective electrical signals,
wherein an audio signal for the second electroacoustical driver is provided on a second driver input, the audio signal for the second electroacoustical driver comprising
(a) a non zero drive signal component; and
(b) a non zero opposition signal component, distinct from the drive signal component, that substantially cancels sympathetic vibration of the second electroacoustical driver caused by acoustic coupling from the first electroacoustical driver in the cabinet enclosure when a first electrical drive signal is applied to a first driver input.

2. An electroacoustical apparatus in accordance with claim 1 wherein said first and second electroacoustical drivers are the same design.

3. An electroacoustical apparatus in accordance with claim 1 wherein said first and second electroacoustical drivers are of differing design.

4. An electroacoustical apparatus in accordance with claim 1 wherein said electrical network is constructed and arranged to provide a second opposition signal on said first input in phase opposition to a second electrical drive signal on said second input to reduce the effect of acoustic coupling from said second electroacoustical driver to said first electroacoustical driver when said second electrical driver signal is applied to said second input.

5. An electroacoustical apparatus in accordance with claim 4 wherein said first and second electroacoustical drivers are of the same design.

6. An electroacoustical apparatus in accordance with claim 4 wherein said first and second electroacoustical drivers are of differing design.

7. An electroacoustical apparatus in accordance with claim 1 wherein said enclosure is sealed.

8. An electroacoustical apparatus in accordance with claim 1, wherein movement X₂ of a cone of the second electroacoustical driver is given by
X₂=V₂*X₂₂+V₁*X₂₁
where V₂ is an input signal applied to the second electroacoustical driver, X₂₂ is the mechanical excursion of the cone of the second electroacoustical driver per unit of V₂, V₁ is the input signal applied to the first electroacoustical driver, and X₂₁ is the mechanical excursion of the cone of the second electroacoustical driver per unit of V₁.
